(19) United States
(12) Patent Application Publication
(10) Pub. No.: US 2017/0032369 A1
(43) Pub. Date: Feb. 2, 2017

(54) METHOD, DEVICE AND FIRST SERVER FOR AUTHORIZING A TRANSACTION

(71) Applicant: GEMALTO, INC., Austin, TX (US)

(72) Inventor: Didier HUGOT, Austin, TX (US)

(73) Assignee: GEMALTO, INC., Austin, TX (US)

(21) Appl. No.: 14/815,271

(22) Filed: Jul. 31, 2015

(51) Int. Cl. G06Q 20/40

(52) U.S. Cl. CPC G06Q 20/401; G06Q 20/4012

(57) ABSTRACT

To authorize a data transaction, a terminal reads user account information from a device. The terminal sends, through a payment network, to a first server a request for authorizing a transaction accompanied with the account information. The first server sends to a device a request for a user approval relating to a transaction. The device requests whether the user approves a requested transaction authorization. Only if the user approves the requested transaction authorization, the device sends to the first server a request for authorizing a transaction and an identifier relating to the device. The first server retrieves, based upon the at identifier relating to the device, the account information. The first server sends to a second server a request for authorizing a transaction and the account information. The second server sends, through the first server and the payment network, to the terminal, either a transaction authorization or a transaction refusal.

### FIELD OF THE INVENTION

The invention relates generally to a method for authorizing a transaction. Furthermore, the invention also pertains to a device for authorizing a transaction. Lastly, the invention relates to a first server for authorizing a transaction as well.

### STATE OF THE ART

As known per se, a Point Of Sale (or POS) terminal reads data from a magnetic stripe of a plastic card, so as to perform a payment transaction from a bank card user account.

However, such a known solution is not secured enough notably due to an easy access to card data by merely reading the card data in plain text. Moreover, the known solution does neither actually verify the cardholder nor authenticate the cardholder. The known solution is therefore not enough protected from fraud.

Thus, there is a need to provide a solution that allows enhancing the protection from fraud to perform a payment transaction.

### SUMMARY OF THE INVENTION

The invention proposes a solution for satisfying the just herein above specified need by providing a method for authorizing a transaction.

According to the invention, the method comprises the following steps. A terminal reads at least one piece of user account information from a first device. The terminal sends, through a payment network, to a first server a first message including a request for authorizing a transaction accompanied with the at least one piece of user account information. The first server sends to the first or a second device a second message including a request for getting a user approval relating to a requested transaction authorization. The first or second device requests a user whether the device user does or does not approve a requested transaction authorization. Only if the device user approves the requested transaction authorization, the first or second device sends to the first server a third message including a request for authorizing a transaction and at least one identifier relating to the first or second device. The first server retrieves, based upon the at least one identifier relating to the first or second device, the at least one piece of user account information. The first server sends to a second server a fourth message including a request for authorizing a transaction and the at least one piece of user account information. The second server sends, through the first server and the payment network, to the terminal, a fifth message including either a transaction authorization or a transaction refusal.

The principle of the invention consists in that, after having received, through a payment network, from a terminal a transaction authorization request along with one or several user account information pieces read from a device, a first server requests an approval from a user of the device or another device. Only if the user approves, the concerned device sends to the first server a transaction authorization request along with one or several identifiers relating to the device. The first server (or another entity) gets, based on the device identifier(s), the user account information piece(s). The first server (or another entity) sends to a second server a transaction authorization along with the user account information piece(s). The second server sends, through the first server and the payment network, to the terminal either an authorization or a refusal to perform the requested transaction.

Thus, a transaction is not authorized without an approval or confirmation of a device user.

Such an invention (payment transaction authorization) solution is based on a confirmation (or a deny) of a transaction request of a user of a device within a banking transaction authorization process. Thus, a (payment) transaction authorization is user dependent.

The invention solution enhances the security of a banking transaction since a concerned user is solicited, through a (predefined) device, like e.g. a mobile (tele)phone, to give (or not), based on a voluntary user action(s), her or his approval prior to continuing a transaction authorization process.

The invention solution also leverages on an existing payment network or infrastructure (or termed back-end system infrastructure).

As the invention solution re-uses the existing payment network, the invention solution is simple and easy to implement.

Furthermore, the invention solution leverages on an existing issuing bank server, as a second server.

To give an approval for the requested transaction authorization, the user may have to perform only a simple action on the concerned device, like e.g. a press on one or several buttons at once or several times.

Thus, a user of the device at the client side that implements the invention method may only need to be quickly involved to give her or his approval (or not) to allow (or disallow) carrying out a payment transaction. The invention method is therefore convenient for the user.

To give her or his approval for the requested transaction authorization, the device user may have to enter user authentication data, like e.g. a Personal Identity Number (or PIN), one or several biometric prints, user credentials, a user name and/or a password.

According to another secure embodiment, only when the user approves the requested transaction authorization, the device or another device, like e.g. a user terminal, generates and sends a transaction cryptogram to the first server along with a request for authorizing the transaction and data relating to the user account information piece(s), like e.g. a Primary Account Number (or PAN) or a Dynamic Primary Account Number (or DPAN), as a so-termed “tokenized” PAN. The first server verifies whether the transaction cryptogram is or is not valid. Only if the transaction cryptogram is valid, the first server retrieves, based on the data relating to the user account information piece(s), the user account information piece(s), like e.g. a PAN. The first server may be a Token Service Provider (or TSP) type server.

The invention solution may further enhance the security of a banking transaction by adding a transaction cryptogram, like e.g. an EMV type cryptogram, that is issued, when the user gives her or his approval, by the device used by the user and to be verified by the first server.

The invention solution may still further enhance the security of a banking transaction by adding a transaction cryptogram that is issued, when the user gives her or his approval, by the device used by the user while taking account of user authentication data, like e.g. an on-line PIN.

The invention method is notably applicable for a transaction using a magnetic stripe card, as a first device, and a terminal, like e.g. a mobile (tele)phone or a Personal Computer (or PC), or a Secure Element (or SE), as a second device used for getting a user approval.

According to a further aspect, the invention is a device for authorizing a transaction.

According to the invention, the device is configured to receive from a first server a second message including a request for getting a user approval relating to a requested transaction authorization. The device is configured to request a user whether the device user does or does not approve a requested transaction authorization. The device is configured to send, only if the device user approves the requested transaction authorization, to the first server a third message including a request for authorizing the transaction.

The device may be a (user) terminal, an embedded chip or a smart card, as an SE.

Within the present description, an SE is a smart object or device that includes a chip that protects, as a tamper resistant component, physically access to stored data and is intended to communicate, preferably in a secure manner, data with the outside world.

The SE chip may be fixed to or removable from a host device.

The invention is notably applicable to a mobile radio-communication field wherein the device is a mobile terminal or a chip that may be embedded, such as an embedded Universal Integrated Circuit Card (or eUICC) within a host device, or removable from a host device, like e.g. a chip included within a smart card termed Subscriber Identity Module (or SIM) type card or the like, as an SE.

The invention does not impose any constraint as to a kind of the SE type.

As a removable SE, it may be a SIM type card, a Secure Removable Module (or SRM), a smart dongle of the USB (acronym for “Universal Serial Bus”) type, a (micro-) Secure Digital (or SD) type card or a Multi-Media type Card (or MMC) or any format card to be coupled or connected to a chip host device.

As to the chip host device, it may be constituted by any electronic device comprising data processing means, data storing means and one or several Input/Output (or I/O) communication interfaces, like e.g. a user terminal.

According to a further aspect, the invention is a first server for authorizing a transaction.

According to the invention, the first server is configured to receive from a terminal, through a payment network, a first message including a request for authorizing a transaction accompanied with at least one piece of user account information. The first server is configured to send to a device a second message including a request for getting a user approval relating to a requested transaction authorization. The first server is configured to receive, only if the device user approves the requested transaction authorization, from the device a third message including a request for authorizing a transaction and at least one identifier relating to the device. The first server is configured to retrieve, based upon the at least one identifier relating to the device, the at least one piece of user account information. The first server is configured to send to a second server a fourth message including a request for authorizing a transaction and the at least one piece of user account information. The first server is configured to receive, from the first server, a message including either a transaction authorization or a transaction refusal. And the first server is configured to send, through the payment network, to the terminal, a message including either a transaction authorization or a transaction refusal.

### BRIEF DESCRIPTION OF THE DRAWINGS

Additional features and advantages of the invention will be more clearly understandable after reading a detailed description of one preferred embodiment of the invention, given as one indicative and non-limitative example, in conjunction with the following drawings:

FIG. 1 is a simplified diagram of a (magnetic stripe) card, a POS terminal, a TSP type server, as a first server, a (card) issuing bank server, as a second server, a mobile Terminal Equipment arranged to get a user approval relating to a transaction authorization requested from the POS terminal along with a PAN read from the magnetic stripe, so as to authorize (or not) the transaction, according to the invention; and

FIG. 2 illustrates a simplified example of a flow of messages exchanged between notably the card, the POS terminal, the mobile TE, the first and second servers of FIG. 1, so that, only if the user approves the requested transaction authorization, the mobile TE generates and sends to the first server a cryptogram to be validated at the server side, prior to receiving at the POS terminal side a response relating to the requested transaction authorization.

### DETAILED DESCRIPTION

Herein under is considered an embodiment in which the invention method for authorizing a transaction that is implemented notably by a magnetic stripe card, as a first device, and an eUICC, as a second device and an SE within a mobile phone, as a host terminal, at a client side.

The SE may also incorporate at least part of the host terminal component(s), like e.g. a baseband processor, an application processor and/or other electronic component(s).

Alternately, instead of an eUICC, the chip may be a Trusted Execution Environment (or TEE), as an SE and a secure area of a terminal processor and a secured runtime environment.

The SE may have different form factors.

Instead of being embedded within its host device, the chip may be carried by a medium, such as a smart card or a dongle, like e.g. a USB type dongle.

According to another embodiment (not represented), the invention method for authorizing a transaction is implemented by a second device, as a standalone entity, at a client side. In other words, the second device, like e.g. a mobile terminal, does not cooperate with any entity, like e.g. an SE, so as to request a user approval and issue a given user response by using, when approved, possibly a cryptogram relating to a transaction. According to such an embodiment, the second device is adapted to carry out the functions that are described infra and that are carried out by the SE and its host terminal, except for a secure storage of data used for generating the cryptogram, when applicable.

According to still another embodiment (not represented), the invention method for authorizing a transaction is implemented by one and the same device, as a standalone entity, at a client side. In other words, the device, like e.g. a mobile terminal or an SE, does not cooperate with any other entity, so as to provide one or several pieces of user account information, to request a user approval and issue a given user response by using, when approved, possibly a cryptogram relating to a transaction. According to such an embodiment, the device is adapted to carry out the functions that are described infra and that are carried out by the magnetic stripe card, the SE and its host terminal, except for a secure storage of data used for generating the cryptogram, when applicable.

Naturally, the herein below described embodiment is only for exemplifying purposes and is not considered to reduce the scope of the invention.

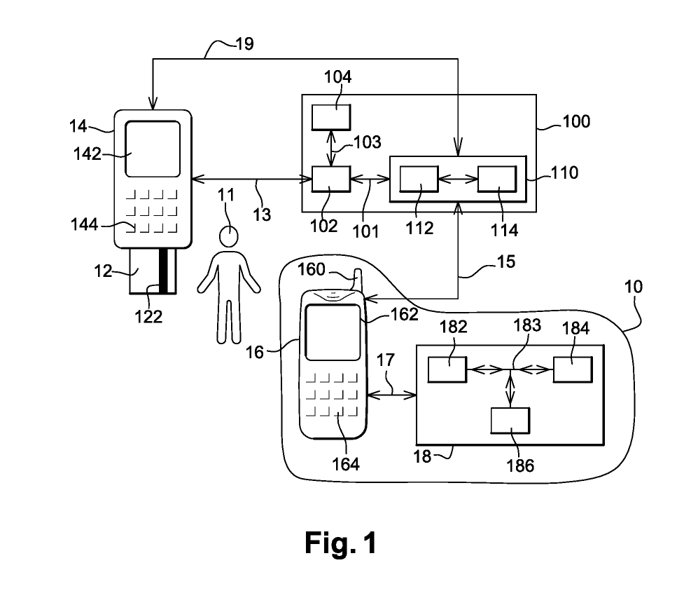

FIG. 1 shows schematically, at a client side, a magnetic stripe card 12, a POS type terminal 14, a mobile Terminal Equipment (or TE) 10, a user 11 and, at a back-end system 100 side, a payment network 102, a first remote server 110 and a second remote server 104.

The mobile TE 10 includes a mobile phone 16, as a (user) terminal, and a chip 18. The chip 18 is soldered, possibly in a removable manner, on a Printed Circuit Board (or PCB) of the mobile phone 16.

For the sake of simplicity, the magnetic stripe card 12, the POS type terminal 14, the mobile phone 16, the chip 18, the payment network 102, the first remote server 110 and the second remote server 104 are termed infra the card 12, the first terminal 14, the second terminal 16, the SE 18, the network 102, the first server 110 and the second server 104 respectively.

A user 11 desires to carry out a (payment) transaction by using her or his card 12 and the second terminal 16.

The card 12, as a first device, is provided with a magnetic stripe 122.

The card 12 stores card data, like e.g. a PAN, an Expiry Date (or ED), and possibly a Card Verification Value (or CVV) or a Card Verification Code (or CVC), as user account information pieces.

The magnetic stripe 122 is provided with the stored card data.

Alternatively, instead of a card, as an SE, the first device includes a watch, a USB type dongle, as an SE, that stores one or several user account information pieces.

Alternately, instead of an SE, the first device includes a PC, a tablet, a mobile phone or any computer device, as a user terminal.

The first terminal 14 may be located within a store or a shop.

The first terminal 14 includes a display screen 142 and a keyboard 144, as a Man Machine Interface (or MMI). Thus, the first terminal 14 exchanges with a user 11.

The first terminal 14 comprises a (micro)processor(s) (not represented), as means for processing data, one or several memories (not represented), as means for storing data, and at least three I/O interfaces (not represented) for exchanging with the outside world.

The first terminal 14 is equipped with a magnetic reading head(s) (not represented), as an I/O interface, so as to read, through a magnetic field, data, like e.g. card data from a magnetic stripe card, like e.g. the card 12.

Alternately, instead of a magnetic reading head(s), the first terminal 14 comprises means for communicating data by using a Short Range (or SR) Radio-Frequency (or RF) link, like e.g. a Near Field Communication (or NFC) link, as a ConTact-Less (or CTL) channel, so as to carry out a proximity (payment) transaction by getting data, like e.g. a PAN or a DPAN, from a mobile terminal that supports a payment application, such as a Host Card Emulation (or HCE) application, or an SE that supports a payment application.

The first terminal 14 is connected, through a first wire or wireless link 13, to the network 102.

The first terminal 14 is connected, through a second wire or wireless link 19, to the first server 110.

The user 11 owns the TE 10 to be involved in a transaction initiated from the user 11 through the first terminal 14 within a transaction authorization process.

The TE 10 is under a radio coverage of a mobile network(s) (not represented) through a Long Range (or LR) RF link(s) 15. The TE user 11 benefits preferably from one or several subscriptions to access, Over The Air (or OTA), through an antenna 160, the mobile network(s).

The mobile network(s), as a cellular communication network(s), may be constituted by a Global System for Mobile Communications (or GSM), a General Packet Radio Service (or GPRS), a Universal Mobile Telecommunications System (or UMTS), an EDGE (acronym for “Enhanced Data Rates for GSM Evolution”), a Code Division Multiple Access (or CDMA) and/or a Long Term Evolution (or LTE) type network(s).

Such a cellular communication network set is not exhaustive but only for exemplifying purposes.

Alternatively or additionally, The TE 10 is under a radio coverage of a local Network Access Point (or NAP) (not represented), like e.g. a set-top box, through an SR RF link. The NAP is connected to an Internet or Intranet type network (not represented). The SR RF link may be related to a Wifi type technology or the like (Bluetooth (registered Trademark), Bluetooth Low Energy (registered Trademark), Zigbee (registered Trademark), NFC . . . ).

The TE 10 is connected, OTA and/or Over The Internet (or OTI), to the first server 110 included within the back-end system 100.

Instead of a phone 16, the second terminal may be any other computer device comprising means for processing data, comprising (or being connected to) wireless communication means for exchanging data with outside and comprising (or being connected to) means for storing data.

The second terminal 16 may be either fixed or mobile.

The second terminal 16 may be a Personal Digital Assistant (or PDA), a vehicle, a set-top box, a tablet computer, a desktop computer, a laptop computer, a PC, a video player, an audio player, a portable TeleVision (or TV), a media-player, a game console, a netbook, an electronic mobile equipment or a device accessory (like e.g. glasses, a watch or a jewel).

The phone 16 comprises a (micro)processor(s), as means for processing data, comprising (or being connected to) wireless communication means for exchanging data with outside and comprising (or being connected to) a memory(ies), as means for storing data.

The phone memory(ies) may comprise one or several memories including one or several volatile memories and one or several non-volatile memories.

The phone memory(ies) may be constituted by one or several EEPROMs (acronym for “Electrically Erasable Programmable Read-Only Memory”), one or several ROMs (acronym for “Read Only Memory”), one or several Flash memories, and/or any other memories of different types, like one or several RAMs (acronym for “Random Access Memory”).

The phone memory(ies) store(s) an Operating System (or OS) and one or several applications.

The phone 16 includes a display screen 162 and a keyboard 164, as a phone MMI.

Alternatively, instead of a physical keyboard separated from the display screen, the phone 16 is equipped with a touch sensitive display screen, as a virtual keyboard.

The phone MMI may allow the user 11 present data to be exchanged with the SE 18, the first 110 and/or the second 104 server.

The phone 16 is connected, through a bi-directional link 17, to the SE 18.

The phone I/O interface with the SE 18 may be an International Organization for Standardization (or ISO) 7816 interface, as a contact interface, when the SE 18 is inserted, in a removable manner, within the phone 16.

Alternately, instead of a contact interface, the phone I/O interface with the SE 18 is connected to or includes a CTL interface. The phone 16 is connected to or includes means for communicating data while using preferably an SR RF link, as a CTL link. The SR RF link may be related to any technology that allows the phone 16 to exchange data, through the CTL link, with the SE 18.

The SE 18 is mainly under a control of the user 11 and/or the phone 16 at the client side.

The SE 18 belongs to the user 11.

The SE 18 includes a (micro)processor(s) 182, as data processing means, a memory(ies) 184, as data storing means, and one or several I/O interfaces 186 that are internally all connected, through an internal bidirectional data bus 183, to each other.

The I/O interface(s) 186 allow(s) exchanging data between the internal SE 18 components to the chip exterior and conversely.

The memory(ies) 184 may store data relating to a Uniform Resource Identifier (or URI), a Uniform Resource Locator (or URL) and/or an Internet Protocol (or IP) address of an external entity(ies) to be addressed, like e.g. the first server 110.

The memory(ies) 184 store(s) an OS.

The memory(ies) 184 may store one or several Subscriber Identity Module (or SIM) type applications. The SIM type application(s) allow(s) the user 11 to identify and authenticate to at least the mobile network(s). To identify the subscriber, the memory(ies) 184 stores, preferably in a secure manner, one or several sets of subscription data. Each subscription data set is identified by an associated International Mobile Subscriber Identity (or IMSI), as a subscription identifier.

The (or each) processor 182 processes, controls and communicates internally data with all the other components incorporated within the SE 18 and, through the I/O interface(s) 186, with the chip exterior.

The processor 182 executes or runs several applications.

Among the supported applications, the memory(ies) 184 store(s) an invention (transaction authorization) application, like e.g. an Europay, Mastercard and Visa (or EMV) type application.

The invention application allows receiving from a requester, like e.g. the first server 110, a request for getting a user approval relating to a requested transaction authorization.

The invention application allows requesting a user whether the SE user 11 does or does not approve a requested transaction authorization.

To solicit the user 11, the SE 18 is able to send to the user 11 a message including a request for getting a user approval. To give her or his approval, the user 11 may execute one or several simple actions, like e.g. pressing, through an MMI (such as the host terminal MMI), one or several buttons, at once, sequentially and/or in combination. The concerned button(s) may include one or several virtual buttons and/or one or several physical buttons.

Such a simple action(s) may be carrying out quickly, so as not to limit an impact on a transaction duration and therefore to avoid a predefined timeout, like e.g. one or several tens of seconds from an initiation of a requested transaction authorization.

Alternately, instead of giving a user approval (or not) within a transaction authorization process, a user activates (or deactivates respectively), from or through the SE 18, the card 12 (or a payment application supported by a computer device, like e.g. the phone 16 or the SE 18) for a predefined count of transaction authorizations prior to corresponding transactions. To activate (or deactivate) the predefined count of transaction authorizations, the user has preferably to enter (or submit) user authentication data to be successfully verified by or through the SE 18.

Alternatively, instead of giving a user approval (or not) within a transaction authorization process, a user validates (or invalidates respectively), from or through the SE 18, the card 12 (or a payment application supported by a computer device, like e.g. the phone 16 or the SE 18) for a predefined count of transaction authorizations prior to corresponding transactions. To validate (or invalidate) the predefined count of transaction authorizations, the user has preferably to enter (or submit) user authentication data to be successfully verified by or through the SE 18.

The invention application allows issuing, only if the SE user 11 approves the requested transaction authorization, to the requester a message including a request for authorizing the concerned transaction along with preferably data that proves that the user 11 gives her or his approval for a requested transaction authorization.

Such data includes data relating to an agreement, like e.g. “OK”, user authentication data to be successfully verified by or through the SE 18, or a transaction cryptogram to be validated by the first server 110.

The user authentication data includes a Personal Identity Number (or PIN), one or several biometric prints, user credentials, a user name and/or a password.

The invention application uses preferably one or several transaction information pieces, like e.g. a transaction amount, preferably a predetermined payment transaction key and possibly other data, like e.g. an Application Transaction Counter (or ATC), as input data to a predetermined (payment transaction) algorithm.

According to a preferred embodiment, the predetermined algorithm, as a first algorithm, is shared between the SE 18 and the first server 110, as a user approval verifier, and includes preferably one or several cryptography algorithms. The first algorithm allows generating preferably an OK Authorization ReQuest Cryptogram (or OK ARQC), as a (payment) transaction cryptogram and a kind of (digital) signature of the concerned transaction. A generation of the transaction cryptogram allows authorizing, only if successfully recognized at the first server 110 side, a requested transaction authorization while securing it.

The invention application may be further protected by user authentication data, like e.g. a PIN, biometric data relating to an authorized user and/or user credentials, like e.g. a password, to be entered or submitted by the user 11. The user authentication data and/or the user credentials is(are) verified locally and/or remotely. The SE 18, as a local verifier, stores or accesses corresponding reference user authentication data and/or reference user credentials to be matched by data entered or submitted by the user at the client side. The SE 18 compares received data entered or submitted by the user to the reference user authentication data and/or the reference user credentials. If the received data does not match the reference user authentication data and/or the reference user credentials, then the SE 18 does not authorize to further execute the concerned invention application and thus aborts its execution. Otherwise, i.e. only in case of identical matching, the SE 18 authorizes to further execute the invention application.

Alternatively, instead of storing securely the invention application within the SE 18, the phone 16 stores the invention application that uses preferably a tokenization mechanism by using e.g. a DPAN, as a so-termed “tokenized PAN”, instead of a PAN, to identify a (bank) user account.

The memory 184 stores the payment transaction key and possibly other payment transaction keys. The (or each) payment transaction key may be restricted in use, like e.g. in time or a certain count of use, like for one (or a few) transaction(s), or permanent. The payment transaction key may be a single use key or a so-termed limited use key.

The memory 184 stores the first algorithm, like e.g. a 3 Data Encryption Standard (or DES) type algorithm. The memory 184 may store other data to be used as input data to the first algorithm, like e.g. a DPAN, an ATC and/or other card data. As known per se, the ATC has a value that is changed for each new transaction.

As input data to the predetermined payment transaction algorithm, there may be an on-line PIN and/or a fingerprint(s), like e.g. an iris print(s) and/or a voice print(s), as user authentication data, to be entered or submitted by the SE user, so as to further secure a transaction authorization. Corresponding reference user authentication data is preferably only stored at a first server 110 side (i.e. not stored at the client side) and used for generating a corresponding reference OK ARQC, so as to further increase the transaction authorization security level. The invention application allows issuing within the message including a request for authorizing the concerned transaction a Bank Identification Number (or BIN) or an Issuer Identification Number (or IIN), so as to identify a concerned (bank) issuer server, as the second server 104.

The SE 18 (or the user 11 by using the phone MMI or a POS terminal MMI) is able to send one or several pieces of transaction information, like e.g. at least a transaction amount, a transaction currency and/or other transaction data, that may be used for generating at least the OK ARQC.

The processor 182 is preferably able to initiate an action(s), in order to interact directly with the outside world independently of the phone 16. Such a capacity of interaction at the initiative of the SE 18 is also known as being a proactive capacity in which the SE 18 plays a role of a master while the SE host device plays a role of a slave. According to one preferred embodiment, the SE 18 is able to use SIM ToolKit (or STK) type commands, as proactive commands.

The SE 18 may be able to send, at its own initiative, either through (or to) the phone 16 or any other device connected to the SE host device, like e.g. the first server 110, a message by using a proactive command, like e.g. a “SEND SHORT MESSAGE”, to send a Short Message Service (or SMS) type message. Such a proactive command allows sending, through the phone 16, to the first server 110 a message including a request for authorizing a transaction accompanied with data relating to user account information and preferably on-board generated data. Such an SMS type message (or the like) conveys the on-board generated data, like e.g. an OK ARQC, to the first server 110, as verifier of such on-board generated data.

The data relating to user account information may be a (digital) token, like e.g. a DPAN. The back-end system 100, like e.g. the first server 110, may carry out a de-tokenization based on a received token, according to such an implementation, to get at least one or several user account information pieces, like e.g. a PAN.

The first server 110 is hosted by a computer with data processing means, data storing means and one or several I/O interfaces.

The first server 110 stores or accesses a memory (not represented) that contains a database (not represented) that includes a set of (bank) user accounts with respective associated data.

The first server 110 manages the database.

Each user account relates to a bank card(s), such as a credit card(s), a debit card(s) and/or another similar card(s), and/or a payment application(s) supported by a user device(s).

Each user account is identified by one or several pieces of user account information, like e.g. at least a PAN, a DPAN, as a “tokenized PAN”, a CVV, a CVC and/or an ED, that are associated with one or several identifiers relating to a device, like e.g. a Mobile Station International Subscriber Directory Number (or MSISDN), an International Mobile station Equipment Identity (or IMEI), an Internet Protocol (or IP) address and/or an International Mobile Subscriber Identity (or IMSI).

The corresponding user account information piece(s) allow(s) identifying a user account to be used for performing a (payment) transaction.

The device identifier(s) allow(s) addressing, through a non-payment (transaction) channel, like e.g. an OTA and/or OTI type channel, the concerned device to be used for involving its user.

At least one of the identified device is to be addressed by the first server 110, so as to be used by a user to be involved to approve a requested transaction authorization.

According to a particular embodiment, the first server 110 includes a TSP type server 112 and a data security verifier 114 that are connected to each other.

The first server 110, and more exactly a TSP server 112, is preferably able to carry out a “tokenization” of user account information, like e.g. to convert a PAN into a corresponding DPAN, as a tokenized PAN, and a “de-tokenization” of the user account information, like e.g. to convert a DPAN into a corresponding PAN, to retrieve one or several (original) user account information pieces.

The first server 110 is able to receive, through a payment network, as a payment (transaction) channel, from a first terminal, like e.g. the POS terminal 14, a message that includes a request for authorizing a transaction accompanied with one or several pieces of user account information, like e.g. at least a PAN and/or a DPAN. The received message includes preferably a transaction amount, a transaction currency and/or other transaction data, as a piece(s) of transaction information. The transaction information piece(s) relate(s) to a product(s) and/or a service(s) that the user 11 requests to buy (or rent) at the first terminal.

The first server 110 plays a role of an intermediary entity between a POS type terminal, a client device(s) to be identified by the first server 110 and the second server 104 that manages financial data for each user account.

The first server 110 is able to send to an identified (or registered) device a message that includes a request for getting a user approval relating to a requested transaction authorization. The user approval request is preferably accompanied with one or several pieces of transaction information to be used for generating, at the device side, data, like e.g. an OK ARQC, to be verified at the first server 110 side, and more exactly by a security data verifier 114. The user approval request may be further accompanied with other data that may be used for generating, at the device side, data to be verified at the first server 110 side.

The first server 110 is able to receive, only if the device user approves the requested transaction authorization, through a or the non-payment channel (i.e. OTA and/or OTI without passing through the payment network), from the (identified) device a message including a request for authorizing the transaction accompanied preferably with data, like e.g. at least an OK ARQC, as a transaction cryptogram, generated at the device side and to be successfully verified by the data security verifier 114. Such a transaction authorization request may be accompanied with a DPAN, as a tokenized PAN, as data relating to the user account information piece(s).

The security data verifier 114 accesses a memory that stores a predetermined payment transaction algorithm including preferably a cryptography algorithm, like e.g. a 3 DES type algorithm, that is shared with the client device, like e.g. the SE 18.

The verifier memory may store, for each user bank account, other data to be used as input data to the predetermined payment transaction algorithm, like e.g. a payment transaction key(s), an ATC and/or other card data.

The verifier memory may store reference user authentication data, like e.g. an on-line PIN and/or on-line biometric data relating to the concerned authorized user, to be entered or submitted by the user at the client side. Alternatively, instead of storing the reference user authentication data (and/or the reference user credentials), the security data verifier 114 accesses it (or them) at the back-end system 100 side.

The security data verifier 114 supports an invention (transaction authorization) verification application. The invention verification application uses preferably one or several transaction information pieces to be received, preferably a predetermined payment transaction key and possibly other data stored at the first server 110 side for the concerned user bank account, as input data to the predetermined (transaction authorization) verification algorithm.

According to a preferred embodiment, the predetermined verification algorithm includes one or several cryptography algorithms, as the first algorithm that is shared with the client device, relating to e.g. an EMV (or the like) type payment application. The first algorithm allows generating a reference OK ARQC, as a reference transaction cryptogram and a kind of (digital) signature of the concerned transaction, to be matched. The verification algorithm may use reference user authentication data that is only stored at the first server 110 side, like e.g. an on-line PIN and/or on-line biometric data, like e.g. a fingerprint(s), an iris print(s) and/or a voice print(s), to be entered or submitted by the user at the client side, so as to generate the reference transaction cryptogram. The reference user authentication data is verified by the security data verifier 114 through a verification of the reference transaction cryptogram to be matched with a transaction cryptogram to be received from the client device.

The security data verifier 114 is thus arranged to verify whether the (received) transaction cryptogram is or is not valid, i.e. whether the (received) transaction cryptogram does or does not match the reference transaction cryptogram.

Only if the transaction cryptogram is valid, i.e. does match the reference transaction cryptogram, the first server 110 is arranged to retrieve, based on the identifier(s) relating to the device, at least the PAN, as a piece(s) of user account information.

The first server 110 is configured to send to a second server 104, as an intermediary transaction authorization verifier, a message that includes a request for authorizing a transaction and the (retrieved) piece(s) of user account information.

Alternately, instead of passing through the second server 104, the first server 110 is configured to send, through the payment channel, to the first terminal a transaction authorization (or a transaction refusal), when the transaction is financially authorized.

The payment network 102 is connected to one or several issuer infrastructures, as one or several second servers. Each second server is preferably operated by an associated bank operator(s) or on its(their) behalf. Each second server manages financial data relating to a set of (bank) user accounts.

The payment network 102 is connected, over a bi-directional link 103, to the second server 104.

The payment network 102 allows identifying the second server 104 that is associated with an identifier(s) of a (bank) issuer. For instance, a PAN includes the concerned issuer identifier(s).

The payment network 102 allows routing data that originates from the first server 110 and/or the client device 16 side to the concerned identified second server 104.

The payment network 102 accesses a database stored in a memory (not represented) that is present within or connected to the payment network 102.

The database may include a correspondence table. The correspondence table includes, for one or several identifiers, like e.g. a BIN or an IIN, as a (bank) issuer identifier, and an identifier(s), such as e.g. a URI and/or a URL, relating to a second server to be addressed for a transaction authorization in progress (and to be processed by the concerned second server 104).

The payment network 102 is able to identify a first device that has been used at the client device side, so as to send to the first device a corresponding transaction authorization or refusal, as a request response.

The second server 104 stores or accesses a database stored in a memory (not represented) that is present within or connected to the second server 104.

Instead of exchanging with the second server 104, the first server 110 may carry out the functions carried out by the second server 104 that is described infra.

The second server 104 manages, among a plurality of user bank accounts, a bank account relating to the SE user 11.

The second server 104 is hosted by a computer with data processing means, such as a processor(s) (not represented), data storing means, like e.g. a memory(ies) (not represented), and one or several I/O interfaces.

The second server 104 is able to receive a message including a request for authorizing a transaction along with e.g. a PAN, as one or several pieces of user account information. The transaction authorization request is preferably accompanied with at least a transaction amount, a transaction currency and/or other transaction data, as a piece(s) of transaction information.

The second server 104 is able to determine whether the requested transaction is or is not financially authorized.

The second server 104 is able to send to the first server 110, as a response to a received authorization request, either an authorization or a refusal for performing a corresponding transaction.

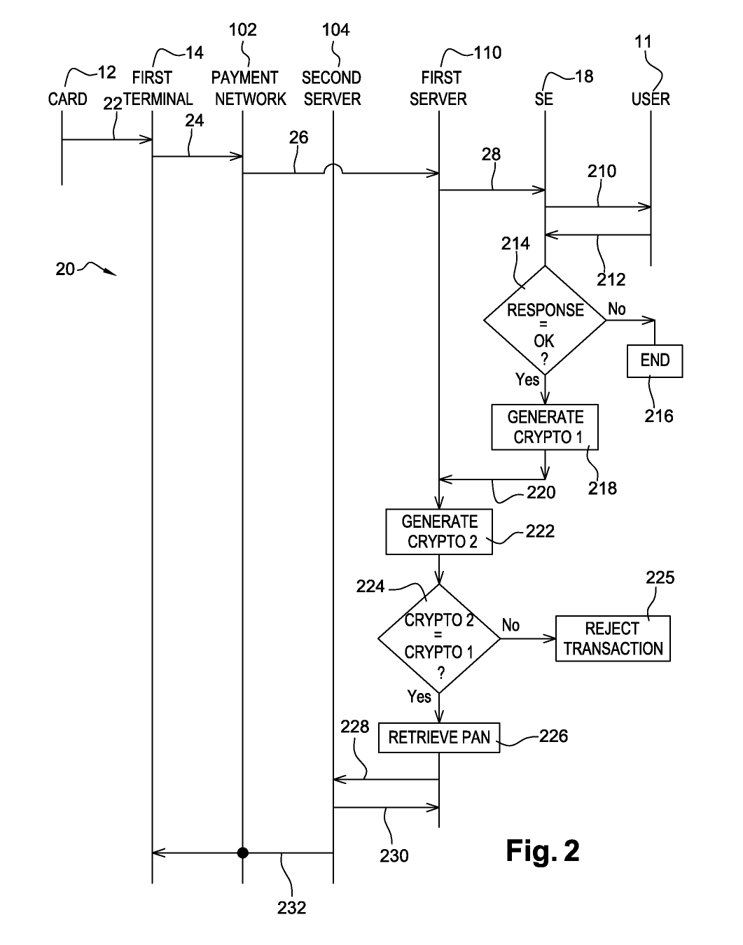

FIG. 2 depicts an exemplary embodiment of a message flow 20 that involves the user 11, the card 12, the first terminal 14, the payment network 102, the first server 110, the second terminal 16 and the second server 104.

In the explained example, it is assumed that the user 11 uses the card 12, as a first device, and the SE 18, as a second device, that generates, when the user 11 approves a requested transaction authorization, an OK ARQC, as a first transaction cryptogram.

It is also assumed that the first server 110 plays a role of an identifier of a second device to be used for getting a user approval and a generator of a reference OK ARQC, as a second transaction cryptogram to be matched, so as to validate (or not) only technically a requested transaction authorization.

It is further assumed that the second server 104 is used for validating (or not), after a successful technically validated transaction authorization, only financially a requested transaction authorization.

The user 11 swipes the magnetic stripe 122 through the magnetic reading head of the first terminal 14. A transaction authorization process is thus launched by the user 11.

The first terminal 14 reads at least a PAN, a CVV and/or an ED, as one or several user account information pieces 22.

The first terminal 14 sends to the payment network 102 a message 24 that includes a request for authorizing a transaction accompanied with the user account information piece(s). The transaction authorization request may be further accompanied with transaction data, like e.g. at least a transaction amount, entered through the first terminal MMI.

The payment network 102 sends to the first server 110 a message 26 that includes a request for authorizing a transaction accompanied with the user account information piece(s). The transaction authorization request is preferably accompanied with one or several pieces of transaction information, like e.g. at least a transaction amount, a transaction currency and/or other transaction data, that is entered through the first terminal MMI by a merchant.

The first server 110 retrieves an IMSI, as an identifier relating to the SE 18, as a registered user device to be used for involving the user 11, based on the received piece(s) of user account information.

The first server 110 sends, through the second terminal (not represented), to the (identified) SE 18 a message 28 that includes a request for getting a user approval relating to a requested transaction authorization. The transaction authorization request is preferably accompanied with one or several pieces of transaction information, like e.g. at least a transaction amount, a transaction currency and/or other transaction data.

The SE 18, and more exactly the supported (transaction authorization) application, sends, through the second terminal MMI, to the user 11 a message 210 for requesting whether the user 11 does or does not approve a requested transaction authorization. The message 210 presents preferably, to the user 11, the received pieces of transaction information.

The user 11 approves or refuses the requested transaction authorization. For instance, the user 11 enters preferably an on-line PIN to give her or his approval, so as to further secure a requested transaction authorization. Alternately, instead of entering an on-line PIN, the user 11 presses a predefined (physical or virtual) button “OK” of the phone 16 MMI to give her or his approval. For instance, the user 11 presses a predefined (physical or virtual) button “CANCEL” of the phone 16 MMI to give her or his refusal.

The SE 18 receives from the user 11 data 212, as request response.

The SE 18 interprets the received data 212.

The SE 18 analyses 214 whether the user does or does not approve the requested transaction authorization.

If the SE 18 determines that the user 11 refuses the requested transaction authorization, then the SE 18 aborts 216 a launched execution of the supported application. After a predefined time duration, like e.g. a few tens of seconds, a timeout occurs and the first server 110 considers that the user 11 refuses the requested transaction authorization due to a lack of any feedback message originating from the SE 18.

Otherwise, i.e. if the SE 18 determines that the user 11 approves the requested transaction authorization, the SE 18 generates 218 a first transaction cryptogram CRYPTO1 while using the entered on-line PIN by further executing the supported application. The SE 18 may erase the entered on-line PIN, as soon as the SE 18 has used it.

The SE 18 sends to the first sever 110 a message 220 that includes a request for authorizing a transaction accompanied with an IMSI, as an identifier relating to the SE 18, the first transaction cryptogram and a DPAN, as a tokenized PAN, as data relating to the piece(s) of user account information.

The first server 110 generates 222 a second transaction cryptogram CRYPTO2, as a reference transaction cryptogram, while using a reference on-line PIN that is preferably only stored at the first server 110 side (i.e. not stored at the client side), by executing the supported (transaction authorization verification) application.

Then, the first server 110 analyses 224 whether the second transaction cryptogram CRYPTO2 does or does not match the first transaction cryptogram CRYPTO1.

If the second transaction cryptogram CRYPTO2 does not match the first transaction cryptogram CRYPTO1, then the first server 110 refuses or rejects 225 (technically) the requested transaction authorization.

Otherwise, i.e. only if the second transaction cryptogram CRYPTO2 matches the first transaction cryptogram CRYPTO1, the first server 110 retrieves 226, based on the IMSI, at least the PAN, the CVV and/or the ED, as the piece(s) relating to the user account information.

The first server 110 sends to the second server 104 a message 228 including a request for authorizing a transaction accompanied with at least the PAN, the CVV and/or the ED, as the piece(s) relating to the user account information. Thus, the first server 110 validates technically the requested transaction authorization. The message 228 includes preferably one or several pieces of transaction information, like e.g. at least a transaction amount, a transaction currency and/or other transaction data.

The second server 104 verifies (not represented) whether data, like e.g. a (credit) balance, relating to the user account information allows or disallows validating financially the requested transaction authorization.

The second server 104 sends to the first server 110 a message 230 that includes either a transaction authorization (i.e. in case of a financial validation) or a transaction refusal (i.e. in case of a financial invalidation), as a request response.

The first server 110 sends, through the payment network 102, to the first terminal 14 either a transaction authorization or a transaction refusal, as a request response.

The invention solution does only slightly involve a client device user, so as to give a user approval possibly by entering user authentication data.

The invention solution allows enhancing greatly a security level relating to a requested transaction authorization notably for a magnetic stripe transaction.

The invention solution is compatible notably with the existing payment network.

The embodiment that has just been described is not intended to limit the scope of the concerned invention. Other embodiments may be given. As another embodiment example, instead of two servers 110 and 104 that are involved, only one server allows authorizing (or not) a requested transaction.

1. A method for authorizing a transaction,
wherein the method comprises the following steps:
a terminal reads at least one piece of user account information from a first device;
the terminal sends, through a payment network, to a first server a first message including a request for authorizing a transaction accompanied with the at least one piece of user account information;
the first server sends to the first or a second device a second message including a request for getting a user approval relating to a requested transaction authorization;
the first or second device requests a user whether the device user does or does not approve a requested transaction authorization;
only if the device user approves the requested transaction authorization, the first or second device sends to the first server a third message including a request for authorizing a transaction and at least one identifier relating to the first or second device;
the first server retrieves, based upon the at least one identifier relating to the first or second device, the at least one piece of user account information;
the first server sends to a second server a fourth message including a request for authorizing a transaction and the at least one piece of user account information;
the second server sends, through the first server and the payment network, to the terminal, a fifth message including either a transaction authorization or a transaction refusal.

2. Method according to claim 1, wherein the device user approves the requested transaction authorization by pressing on at least one button.

3. Method according to claim 1, wherein the device user approves the requested transaction authorization by entering user authentication data to be successfully verified by or through the second device.

4. Method according to claim 3, wherein the user authentication data includes at least one element of a group comprising:
a Personal Identity Number;
at least one biometric print;
user credentials;
a user name;
a password.

5. Method according to claim 1, wherein, only when the device user approves the requested transaction authorization, the first or second device generates a transaction cryptogram and sends to the first server a third message including a request for authorizing the transaction, at least one identifier relating to the first or second device, the transaction cryptogram and data relating to the at least one piece of user account information, the first server verifies whether the transaction cryptogram is or is not valid, only if the transaction cryptogram is valid, the first server retrieves, based upon the data relating to the at least one piece of user account information, the at least one piece of user account information.

6. Method according to claim 5, wherein the data relating to the at least one piece of user account information includes a Dynamic Primary Account Number or a Primary Account Number.

7. Method according to claim 1, wherein the first message, the second message and the third message further include at least one piece of transaction information.

8. A device for authorizing a transaction,
wherein the device is configured to:
receive from a first server a second message including a request for getting a user approval relating to a requested transaction authorization;
request a user whether the device user does or does not approve a requested transaction authorization;
send, only if the device user approves the requested transaction authorization, to the first server a third message including a request for authorizing the transaction.

9. Device according to claim 8, wherein the device includes a user terminal or a token.

10. A first server for authorizing a transaction,
wherein the first server is configured to:
receive from a terminal, through a payment network, a first message including a request for authorizing a transaction accompanied with at least one piece of user account information;
send to a device a second message including a request for getting a user approval relating to a requested transaction authorization;
receive, only if the device user approves the requested transaction authorization, from the device a third message including a request for authorizing a transaction and at least one identifier relating to the device;
retrieve, based upon the at least one identifier relating to the device, the at least one piece of user account information;
send to a second server a fourth message including a request for authorizing a transaction and the at least one piece of user account information;
receive, from the first server, a message including either a transaction authorization or a transaction refusal; and
send, through the payment network, to the terminal, a message including either a transaction authorization or a transaction refusal.
